(19) United States
(12) Patent Application Publication
(10) Pub. No.: US 2011/0043989 A1
(43) Pub. Date: Feb. 24, 2011

(54) MOTHERBOARD AND PORTABLE ELECTRONIC DEVICE USING THE SAME

(76) Inventors: Kai-Chen Tien, TAIPEI CITY (TW); Chih-Hsiung Lin, TAIPEI CITY (TW); Chih-Chieh Chou, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/857,550

(22) Filed: Aug. 16, 2010

(30) Foreign Application Priority Data
Aug. 18, 2009 (TW) 098127690

(51) Int. Cl. G06F 1/16

(52) U.S. Cl. 361/679.4

(57) ABSTRACT

This invention provides a motherboard and a portable electronic device using the same. The motherboard includes a first circuit board and a second circuit board. The first circuit board includes a first connector, an input/output controller, and a plurality of peripheral device connectors. The input/output controller is electrically connected with the first connector and the peripheral device connectors, respectively. The second circuit board includes a second connector, a central processing unit (CPU), and a chipset. The chipset is electrically connected with the second connector and the CPU, respectively. The first circuit board is connected with the second circuit board via the first connector and the second connector.

### CROSS-REFERENCE TO RELATED APPLICATIONS

This Non-provisional application claims priority under 35 U.S.C. §119(a) on Patent Application No(s). 098127690 filed in Taiwan, Republic of China on Aug. 18, 2009, the entire contents of which are hereby incorporated by reference.

### BACKGROUND OF THE INVENTION

1. Field of the Invention

This invention relates to a motherboard and, more particularly, to a motherboard and a portable electronic device using the same.

2. Description of the Related Art

A motherboard is a necessary component of a computer, and quality of the motherboard determines efficiency of the whole computer. Generally speaking, in the computer, electronic components, control chips, connecting ports and so on are all disposed at the motherboard, and the components and the components and the chips are connected with each other via cables disposed at the motherboard thus to achieve communication.

Usually, the motherboard in the computer is a single board. FIG. 1 is a schematic diagram showing the motherboard in the prior art. In FIG. 1, a central processing unit (CPU) 10, a north bridge chip 11, and a south bridge chip 12 are disposed at a motherboard 1. The north bridge chip 11 is connected with a display interface 13 and a memory 14, respectively, for achieving communication between the CPU 10 and the display interface 13 or the memory 14. The south bridge chip 12 is used for being connected with peripheral interfaces, such as an integrated drive electronics (IDE) port 15, an extended capability (EC) port 16, a universal serial bus (USB) port 17, a peripheral component interconnect (PCI) port 18 and so on, thus to achieve communication between the CPU 10 and peripheral devices.

However, with development of technology, after a CPU or a chipset with a certain specification is released, updated products with powerful functions may be subsequently researched and developed. To upgrade a system, a user has to replace kernel components of a motherboard. However, the kernel components, such as the CPU, the chipset and so on, and other electronic components, such as the control chips, the connecting ports and so on, are disposed at the motherboard together. Therefore, the user has to replace the whole motherboard.

On the other hand, for computer systems with the same specification, peripheral device connectors needed by the computer systems are not the same. Further, positions of the peripheral device connectors may be changed with a position of the motherboard. However, since the motherboard used in the current computer system is a single board, when the peripheral device connector needs to be replaced with a different one or the position thereof needs to be changed, the whole motherboard needs to be redesigned and remanufactured.

The above method not only needs a lot of expense, but also increases the number of discarded circuit boards, which causes costs to be wasted.

### BRIEF SUMMARY OF THE INVENTION

One objective of this invention is to provide a motherboard and a portable electronic device using the same to improve the prior art.

According to one aspect of the invention, the invention provides a motherboard including a first circuit board and a second circuit board. The first circuit board includes a first connector, an input/output controller, and a plurality of peripheral device connectors. The input/output controller is electrically connected with the first connector and the peripheral device connectors, respectively. The second circuit board includes a second connector, a central processing unit (CPU), and a chipset. The chipset is electrically connected with the second connector and the CPU, respectively. The first circuit board is connected with the second circuit board via the first connector and the second connector.

According to another aspect of the invention, the invention provides a portable electronic device including a casing and a motherboard. The motherboard is disposed at the casing and includes a first circuit board and a second circuit board. The first circuit board includes a first connector, an input/output controller, and a plurality of peripheral device connectors. The input/output controller is electrically connected with the first connector and the peripheral device connectors, respectively. The second circuit board includes a second connector, a CPU, and a chipset. The chipset is electrically connected with the second connector and the CPU, respectively. The first circuit board is connected with the second circuit board via the first connector and the second connector.

According to the motherboard in the invention, kernel components, such as the CPU, the chipset and so on, and other components are separately disposed at the two independent circuit boards. Thus, the kernel components of the second circuit board can be separately replaced to upgrade the motherboard, without affecting the other electronic components, such that an update of the motherboard can be more convenient and flexible, thereby reducing product costs. Further, computer systems with the same specification can use the same second circuit board, and the first circuit board can be correspondingly designed according to a position of the motherboard, thereby improving sharing between platforms with the same configuration.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a motherboard in the prior art.

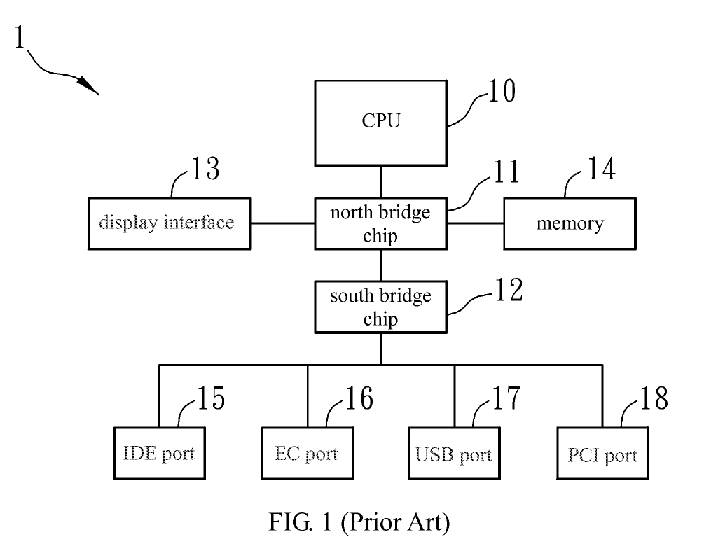

FIG. 2 is an exploded diagram showing a motherboard according to one preferred embodiment of the invention.

FIG. 3 is a block diagram showing a motherboard according to one preferred embodiment of the invention.

FIG. 4 is a schematic diagram showing a motherboard according to another preferred embodiment of the invention.

FIG. 5 is a schematic diagram showing a portable electronic device according to one preferred embodiment of the invention.

### DETAILED DESCRIPTION OF THE INVENTION

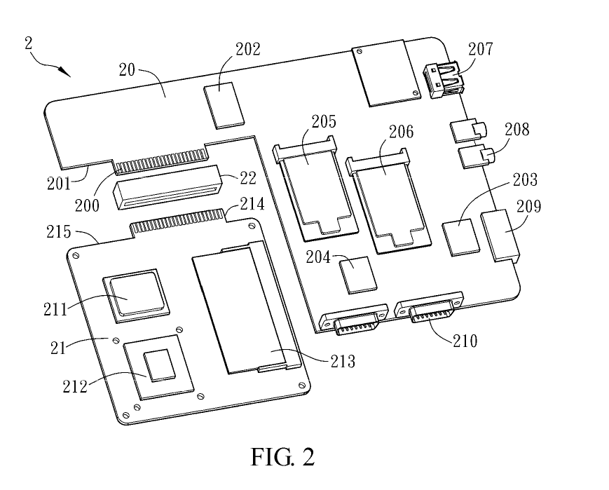

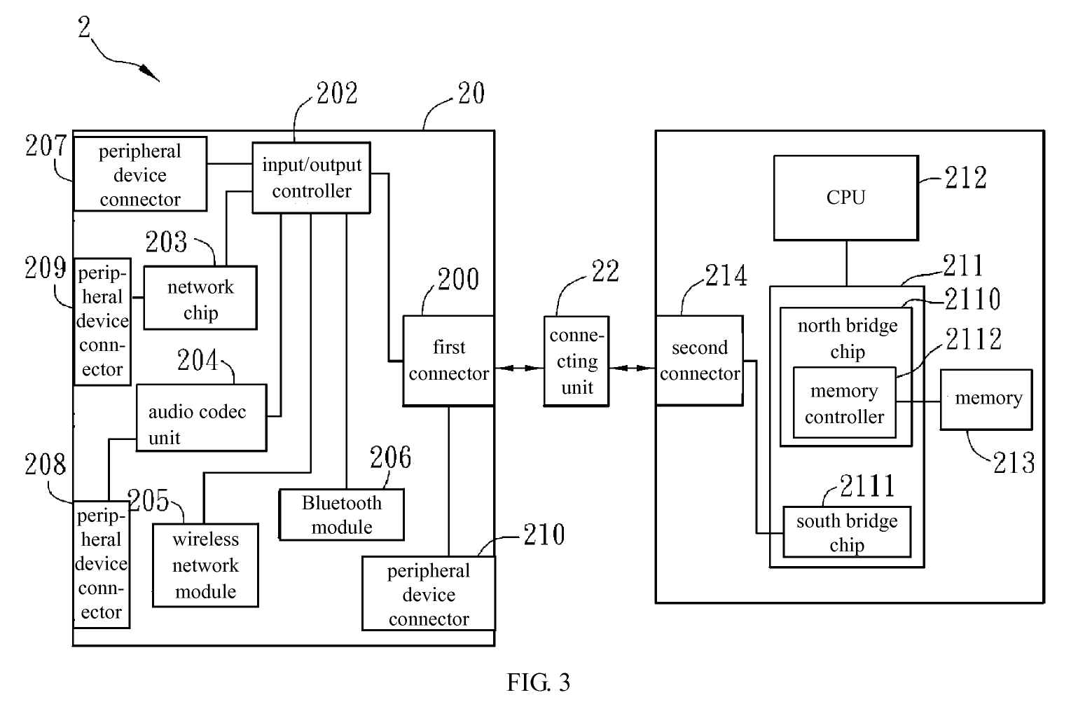

FIG. 2 is an exploded diagram showing a motherboard according to one preferred embodiment of the invention. FIG. 3 is a block diagram showing a motherboard according to one preferred embodiment of the invention. Please refer to FIG. 2 and FIG. 3 together. According to the embodiment, a motherboard 2 includes a first circuit board 20, a second circuit board 21, and a connecting unit 22. The first circuit board 20 includes a first connector 200, and the second circuit board 21 includes a second connector 214. In the embodiment, the first circuit board 20 can be electrically connected with the second circuit board 21 via the first connector 200, the second connector 214, and the connecting unit 22, and the first circuit board 20 and the second circuit board 21 are separable. The first circuit board 20 and the second circuit board 21 may be multilayer circuit boards, and circuit layers of the first circuit board 20 may be the same as or different from that of the second circuit board 21. For example, the circuit layers of the second circuit board 21 may be more than that of the first circuit board 20. However, the invention is not limited thereto.

In the embodiment, the first circuit board 20 further includes an input/output controller 202, a network chip 203, an audio codec unit 204, a wireless network module 205, a Bluetooth module 206, and a plurality of peripheral device connectors 207, 208, 209, and 210.

In the embodiment, the input/output controller 202 is an embedded controller (EC). In other embodiments, the input/output controller 202 may be a super input/output (Super 10) controller. In the embodiment, the peripheral device connector 207 is a USB connector; the peripheral device connector 208 is an earphone inserting hole; the peripheral device connector 209 is a network connector (such as an RJ45 connector); the peripheral device connector 210 is a display interface connector. In other embodiments, the peripheral device connectors 207, 208, 209, and 210 may be connectors in other types. However, the types of the peripheral device connectors 207, 208, 209, and 210 are not limited in the invention.

In the embodiment, the wireless network module 205 and the Bluetooth module 206 are designed to be disposed at the first circuit board 20 according to needs. In other embodiments, the Bluetooth module 206 and/or the wireless network module 205 may not be disposed at the first circuit board 20. In addition, the positions and number of the peripheral device connectors 207, 208, 209, and 210 of the first circuit board 20 may also be changed. That is, various kinds of first circuit boards 20 with different functions or shapes designed according to different needs may be electrically connected with the second circuit board 21 via the first connector 200, the second connector 214, and the connecting unit 22 in the embodiment.

In other words, in the embodiment, the same second circuit board 21 can be electrically connected with different first circuit boards 20. The positions of the peripheral device connectors 207, 208, 209, and 210 of the different first circuit boards 20 are different, or the board shapes of the different first circuit boards 20 are different. Thus, for computer devices in various types, core of the motherboards thereof can be the same second circuit board 21, and the computer devices in various types can use the first circuit boards 20 in various types.

In FIG. 2, in the embodiment, the first circuit board 20 may be L-shaped and may have a first edge 201. The first connector 200 can be disposed at the first edge 201. In other embodiments, the first circuit board 20 may be a rectangle, and the first connector 200 may be disposed at any edge of the rectangle. However, the shape of the first circuit board 20 and the position of the first connector 200 are not limited in the invention.

In FIG. 2 and FIG. 3, in the embodiment, the second circuit board 21 further includes a chipset 211, a central processing unit (CPU) 212, and a memory 213.

In the embodiment, the chipset 211 includes a north bridge chip 2110 and a south bridge chip 2111. The north bridge chip 2110 includes a memory controller 2112. In other embodiments, the north bridge chip 2110 and the CPU 212 may be integrated into one unit, and the chipset 211 may only include the south bridge chip 2111.

In the embodiment, the north bridge chip 2110 in the chipset 211 is electrically connected with the CPU 212 and the memory 213, respectively. The south bridge chip 2111 in the chipset 211 is electrically connected with the north bridge chip 2110 and the second connector 214, respectively.

The memory controller 2112 is used for controlling operation of the memory 213. In the embodiment, the memory 213 is a DDR II memory. In other embodiments, the memory 213 may be a DDR III memory. However, the type of the memory 213 is not limited in the invention.

In the embodiment, the memory 213 and the CPU 212 can transfer data therebetween via the north bridge chip 2110. For example, when the data are transferred from the CPU 212 to the memory 213, the data need to be transferred to the north bridge chip 2110 via a system bus, and then the data may be transferred to the memory 213.

In FIG. 2, the second circuit board 21 has a second edge 215. The second connector 214 is disposed at the second edge 215 for communicating with the first connector 200 at a high speed. In the embodiment, the first connector 200 and the second connector 214 are a mobile PCI express module (MXM) connector, respectively. In other embodiments, the first connector 200 and the second connector 214 may also be high-frequency connectors in other types, and a transferring bandwidth of the high-frequency connector may be at least 1 Gbps.

Thus, the second circuit board 21 as a kernel platform can transfer data to the first circuit board 20 with a peripheral function. In the embodiment, the so-called kernel platform refers to a printed circuit board including the CPU 212, the chipset 211 cooperating therewith, and related control logic chips. In the embodiment, the circuit board with the peripheral function refers to a circuit board having various kinds of input/output connectors, control chips thereof, and various kinds of functional modules (such as a wireless module and a Bluetooth module).

In the embodiment, when the first circuit board 20 is connected with the second circuit board 21, the first edge 201 is adjacent to the second edge 215.

In the embodiment, the first connector 200 and the second connector 214 are both connectors in a golden finger form and protrude from the first edge 201 and the second edge 215, respectively. The connecting unit 22 is a female connector capable of accepting the connectors in the golden finger form. When the first connector 200 and the second connector 214 are inserted into two sides of the connecting unit 22, respectively, the first circuit board 20 and the second circuit board 21 are connected with each other thus to achieve electrical connection. The above connecting mode in the embodiment is called cascade connection. However, the connecting mode of the first circuit board 20 and the second circuit board 21 is not limited in the invention.

In the embodiment, when a user is to upgrade the motherboard 2, for example, when the user replaces the CPU 212 and the chipset 211 cooperating therewith those of a new generation, since the above kernel platform components are all disposed at the second circuit board 21, the user only needs to replace the second circuit board 21.

After the upgrade of the second circuit board 21 is finished, via cooperation of the first connector 200, the second connector 214, and the connecting unit 22, the first circuit board 20 and the second circuit board 21 can be electrically connected with each other thus to communicate therebetween. Further, the second circuit board 21 can communicate with the components of the first circuit board 20 via the chipset 211.

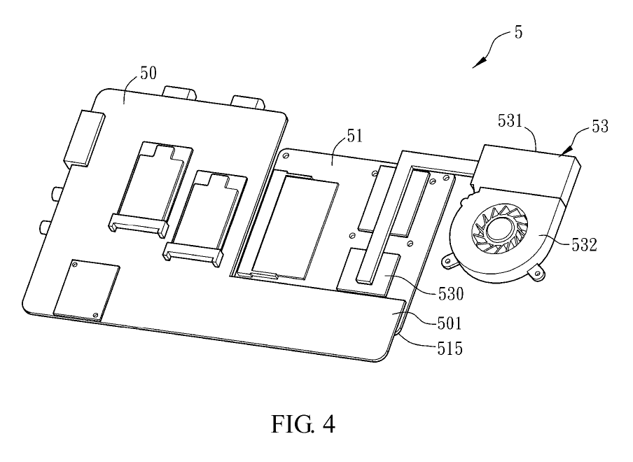

FIG. 4 is a schematic diagram showing a motherboard according to another preferred embodiment of the invention. In FIG. 4, according to the embodiment, the motherboard 5 includes a first circuit board 50, a second circuit board 51, and a heat dissipating unit 53. The heat dissipating unit 53 can be disposed at the first circuit board 50 or the second circuit board 51. In the embodiment, the heat dissipating unit 53 is disposed at the second circuit board 51.

In the embodiment, the first circuit board 50 and the second circuit board 51 are the same as those in the above embodiment. Therefore, they are not described herein for a concise purpose. Only the difference is described hereinbelow.

In the embodiment, the first circuit board 50 is connected with the second circuit board 51 in an overlap connecting mode. That is, the first circuit board 50 and the second circuit board 51 overlap. In other words, a horizontal height of the first circuit board 50 is different from that of the second circuit board 51, and a horizontal plane of the first circuit board 50 and that of the second circuit board 51 have a height difference.

In FIG. 4, a first edge 501 of the first circuit board 50 and a second edge 515 of the second circuit board 51 overlap with each other. Further, a first connector (not shown) may be disposed at the first edge 501 of one surface (such as a bottom surface) of the first circuit board 50, and a second connector (not shown) may be disposed at the second edge 515 of one surface (such as an upper surface) of the second circuit board 51.

In the embodiment, the first connector can have a plurality of pins, and the second connector can have a plurality of contacting portions corresponding to the pins. The pins contact the contacting portions thus to achieve electrical connection of the first circuit board 50 and the second circuit board 51. However, the overlap connecting mode of the first circuit board 50 and the second circuit board 51 is not limited in the invention.

If the first circuit board 50 is connected with the second circuit board 51 in the above overlap connecting mode, the height difference exists between the two circuit boards 50, 51. In the embodiment, the heat dissipating unit 53 is disposed at the circuit board with a lower position around the overlap portion.

In the embodiment, the heat dissipating unit 53 includes a heat conducting plate 530, a wind guiding cover 531, and a fan 532. The wind guiding cover 531 is used for guiding a wind flow generated by the fan 532 to the motherboard 5.

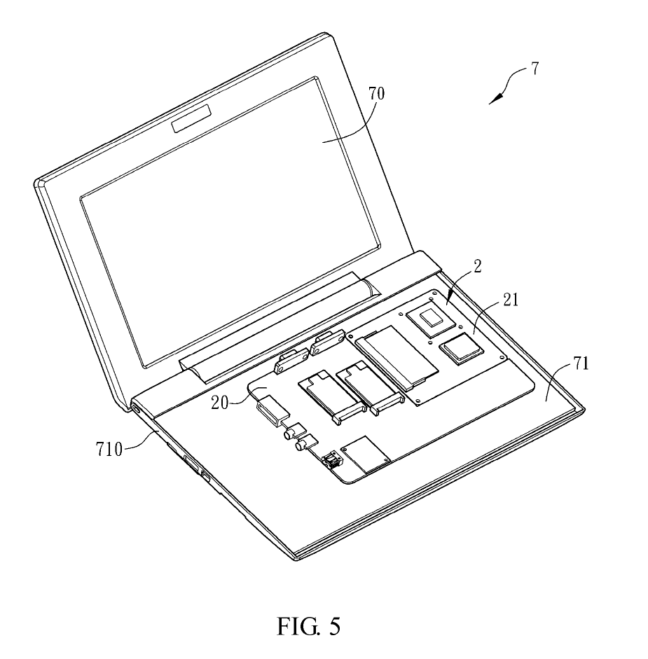

FIG. 5 is a schematic diagram showing a portable electronic device according to one preferred embodiment of the invention. In FIG. 5, according to the embodiment, a portable electronic device 7 includes a display 70 and a host 71. In the embodiment, the portable electronic device 7 can be a notebook computer. However, the invention is not limited thereto.

In the embodiment, the host 71 includes a casing 710 and a motherboard 2. The motherboard 2 is disposed in the casing 710. In the embodiment, the motherboard 2 includes a first circuit board 20 and a second circuit board 21.

In the embodiment, the first circuit board 20 and the second circuit board 21 are the same as those in the above embodiment. The detailed structure of the motherboard 2 is described according to FIG. 2.

When the first circuit board 20 or the second circuit board 21 needs to be upgraded or changed, the corresponding circuit board can be disassembled, such that components can be replaced. After the above operation is finished, via the cooperation of the first connector 200, the second connector 214, and the connecting unit 22, the first circuit board 20 and the second circuit board 21 can be electrically connected with each other to communicate therebetween.

To sum up, according to the preferred embodiments of the invention, the motherboard includes the two independent circuit boards. The motherboard can be upgraded by using the second circuit board with kernel components of a newer generation alone, such that the upgrade of the motherboard is more flexible and convenient. Further, computer systems with the same specification can use the same second circuit board, and the first circuit board can be correspondingly designed according to a position of the motherboard, thereby improving sharing between platforms with the same configuration. In addition, the two circuit boards are electrically connected with each other via the high-frequency connectors, thereby improving expandability of the motherboard of the system. In another embodiment, the two circuit boards are electrically connected in the overlap connecting mode, and the heat dissipating unit is disposed around the overlap position, thereby compensating the height difference generated by the overlap connection of the two circuit boards and providing heat dissipation for the motherboard as well.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A motherboard comprising:
a first circuit board including a first connector, an input/output controller, and a plurality of peripheral device connectors, the input/output controller electrically connected with the first connector and the peripheral device connectors, respectively; and
a second circuit board including a second connector, a central processing unit (CPU), and a chipset, the chipset electrically connected with the second connector and the CPU, respectively,
wherein the first circuit board is connected with the second circuit board via the first connector and the second connector.

2. The motherboard according to claim 1, wherein the first connector and the second connector are a high-frequency connector, respectively, and a transferring bandwidth of the high-frequency connector is at least 1 Gbps.

3. The motherboard according to claim 1, further comprising a connecting unit coupled with the first connector and the second connector, respectively, the first connector and the second connector communicating with each other at a high speed via the connecting unit.

4. The motherboard according to claim 1, wherein the first circuit board and the second circuit board overlap.

5. The motherboard according to claim 4, further comprising a heat dissipating unit disposed at the first circuit board or the second circuit board.

6. The motherboard according to claim 1, wherein the second circuit board further comprises a memory.

7. The motherboard according to claim 1, wherein the chipset comprises a north bridge chip and a south bridge chip.

8. The motherboard according to claim 1, wherein the chipset comprises a south bridge chip.

9. The motherboard according to claim 1, wherein the first circuit board and the second circuit board are multilayer circuit boards, and circuit layers of the second circuit board are more than that of the first circuit board.

10. The motherboard according to claim 1, wherein the first circuit board further comprises a network chip and an audio codec unit.

11. A portable electronic device comprising:
a casing; and
a motherboard disposed at the casing, the motherboard including:
a first circuit board including a first connector, an input/output controller, and a plurality of peripheral device connectors, the input/output controller electrically connected with the first connector and the peripheral device connectors, respectively; and
a second circuit board including a second connector, a CPU, and a chipset, the chipset electrically connected with the second connector and the CPU, respectively,
wherein the first circuit board is connected with the second circuit board via the first connector and the second connector.

12. The portable electronic device according to claim 11, wherein the first connector and the second connector are a high-frequency connector, respectively, and a transferring bandwidth of the high-frequency connector is at least 1 Gbps.

13. The portable electronic device according to claim 11, wherein the motherboard further comprises a connecting unit coupled with the first connector and the second connector, respectively, and the first connector and the second connector communicate with each other at a high speed via the connecting unit.

14. The portable electronic device according to claim 11, wherein the first circuit board and the second circuit board overlap.

15. The portable electronic device according to claim 14, wherein the motherboard further comprises a heat dissipating unit disposed at the first circuit board or the second circuit board.

16. The portable electronic device according to claim 11, wherein the second circuit board further comprises a memory.

17. The portable electronic device according to claim 11, wherein the chipset comprises a north bridge chip and a south bridge chip.

18. The portable electronic device according to claim 11, wherein the chipset comprises a south bridge chip.

19. The portable electronic device according to claim 11, wherein the first circuit board and the second circuit board are multilayer circuit boards, and circuit layers of the second circuit board are more than that of the first circuit board.

20. The portable electronic device according to claim 11, wherein the first circuit board further comprises a network chip and an audio codec unit.
